(19) United States
(12) Patent Application Publication
(10) Pub. No.: US 2007/0035780 A1
(43) Pub. Date: Feb. 15, 2007

(54) System and method for defining characteristic data of a scanned document

(75) Inventor: Hiroki Kanno, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/194,575

(22) Filed: Aug. 2, 2005

(51) Int. Cl. H04N 1/00

(52) U.S. Cl. 358/403

(57) ABSTRACT

A system and a method for providing characteristic data associated with a scanned document is provided. The characteristic data of the document may include a title, a creation date, a scan date, an author, a subject matter, a total page count, a starting page number, an ending page number, a color type, a document type, a language, and/or a document direction. The method includes analyzing a bitmapped image file of a document, determining at least one characteristic data of the document based on the analysis of the bitmapped image file, and linking the characteristic data to the bitmapped image file, wherein the characteristic data is useable by a document management system to identify the document in a search. Analyzing the bitmapped image of the document may include a natural language analysis technique, an optical character recognition analysis technique, an image layout analysis technique, and/or a color analysis technique.

### FIELD OF THE INVENTION

The present invention relates generally to document management systems and, more particularly, to a system and a method for automatically defining characteristic data associated with a document created by scanning from a paper version of the document.

### BACKGROUND OF THE INVENTION

In the currently highly computerized business and home environments, electronic copies of documents are routinely available. As such, these documents can be controlled in a straightforward manner using existing document management systems. A document management system facilitates the maintenance, retrieval, display, and accessibility of a large number of documents by multiple users. Using a document management system, a user may identify a specific document stored in the document management system from among a large number of documents. Characteristic data is saved and associated with each document to facilitate subsequent identification of the document by users in the future. For example, a user may know the author of a document of interest and part of the title of the document. Using the document management system, the user specifies the known query items (e.g., the author and the partial title) and submits a search for the document within the document management system. The system searches the characteristic data associated with each document for a match with the query items and presents the matching documents to the user for review, for printing, for editing, etc.

There are, however, still instances wherein an electronic version of a document is not available. Instead, to obtain an electronic version of the document, the document is scanned using an image scanner that obtains image data by photoelectrically converting reflected light obtained from illumination of the document. The image scanner generally includes an illuminating unit having an illuminating lamp for illuminating the document placed on a document table of the scanner, a Charge-Coupled Device (CCD) sensor serving as an image scanning sensor, and an optical set (plural mirrors and reducing glass lenses) provided between the document table and the CCD sensor to image the light reflected from the document on the CCD sensor. In the conventional printing field, a so-called line pattern image recording technique is known. The line pattern image recording technique is a method of representing an image-created using an image scanner by a pattern consisting of a group of lines arranged in parallel periodically across the face of the document. Each line is comprised of pixel values of a plurality of pixels arranged in the direction of the line that represent the content of that pixel on the document. The width of the lines represents the gradation of the image. In a black and white image, each pixel may be represented with a single bit containing a “1” or a “0” that represents a black or a white pixel. In multicolor processing, signals output from the scanner may be Red-Green-Blue (RGB) image signals that may be represented using a plurality of bits depending on the color resolution specified.

The resulting scanned data, which comprises pixels arranged. in lines across the entire document, may be saved in a variety of formats. However, regardless of the specific format, the basic underlying format of the scanned document is a bitmap based on the limited information available for the scanned image of pixels. A bitmap is a data file or structure that corresponds bit for bit with an image displayed on a screen, typically in the same format as it would be stored in the display's video memory. A bitmap is characterized by the width and height of the image in pixels and the number of bits per pixel. The number of bits per pixel determines the number of shades of grey or the number of colors used to represent the bitmap. A bitmap representing a color image typically has pixels defined using one to eight bits for each of the red, green, and blue components, though other color encodings may also be used.

The Tagged Image File Format (TIFF) is also commonly used to store bit-mapped images on computers of all form factors. TIFF was designed to provide a common format for image scanners, and is mainly used for scanning, desktop publishing, and as the data format for scanned faxes. TIFF utilizes a structure that can store image data and attributes of the stored image data. The fields defined in the TIFF specification are of a descriptive nature and provide information that is useful to facilitate viewing and rendering of images by a recipient of the image.

Bitmapped images, however, are difficult to manage in a document management system based on the limited automatic information available to describe the document. For example, an electronically created document often has a title, an author, a document type, keywords, a creation date, etc. that may be associated with the document during the document creation to allow a search for the document stored in a document management system based on this information. To obtain this information for a scanned bitmapped image, the information must be entered into the document management system manually for each document which may cause sometimes significant time delays and is inconvenient to users. It would be useful to have a system and a method that automatically identifies searchable information relating to a scanned document to improve management within a document management system.

### SUMMARY OF THE INVENTION

An exemplary embodiment of the invention relates to a method for providing characteristic data associated with a document. The method includes, but is not limited to, analyzing a bitmapped image file of a document, determining at least one characteristic data of the document based on the analysis of the bitmapped image file, and linking the characteristic data-to the bitmapped image file, wherein the characteristic data is useable by a document management system to identify the document in a search.

Another exemplary embodiment of the invention relates to one or more computer-readable media having computer-readable instructions stored thereon that, upon execution by a processor, cause the processor to provide characteristic data associated with a document. The instructions include, but are not limited to analyzing a bitmapped image file of a document, determining at least one characteristic data of the document based on the analysis of the bitmapped image file, and linking the characteristic data to the bitmapped image file, wherein the characteristic data is useable by a document management system to identify the document in a search.

Yet another exemplary embodiment of the invention relates to a device for providing characteristic data associated with a document. The device includes, but is not limited to, a characteristic data analyzer application, a memory, and a processor. The characteristic data analyzer application includes, but is not limited to, computer-readable instructions configured to analyze a bitmapped image file of a document, to determine at least one characteristic data of the document based on the analysis of the bitmapped image file, and to link the characteristic data to the bitmapped image file, wherein the characteristic data is useable by a document management system to identify the document in a search. The memory stores the characteristic data analyzer application. The processor couples to the memory and is configured to execute the characteristic data analyzer application.

Other principal features and advantages of the invention will become apparent to those skilled in the art upon review of the following drawings, the detailed description, and the appended claims.

### BRIEF DESCRIPTION OF THE DRAWINGS

FIG. 1 is a block diagram of a system in accordance with an exemplary embodiment of the present invention.

FIG. 2 is a flow diagram illustrating exemplary operations of a data analyzer application in accordance with an exemplary embodiment of the present invention.

FIG. 3 is a block diagram of a device in accordance with an exemplary embodiment of the present invention.

FIG. 4 is a graphical representation for determining layout direction of an exemplary page.

### DETAILED DESCRIPTION OF PREFERRED EMBODIMENTS

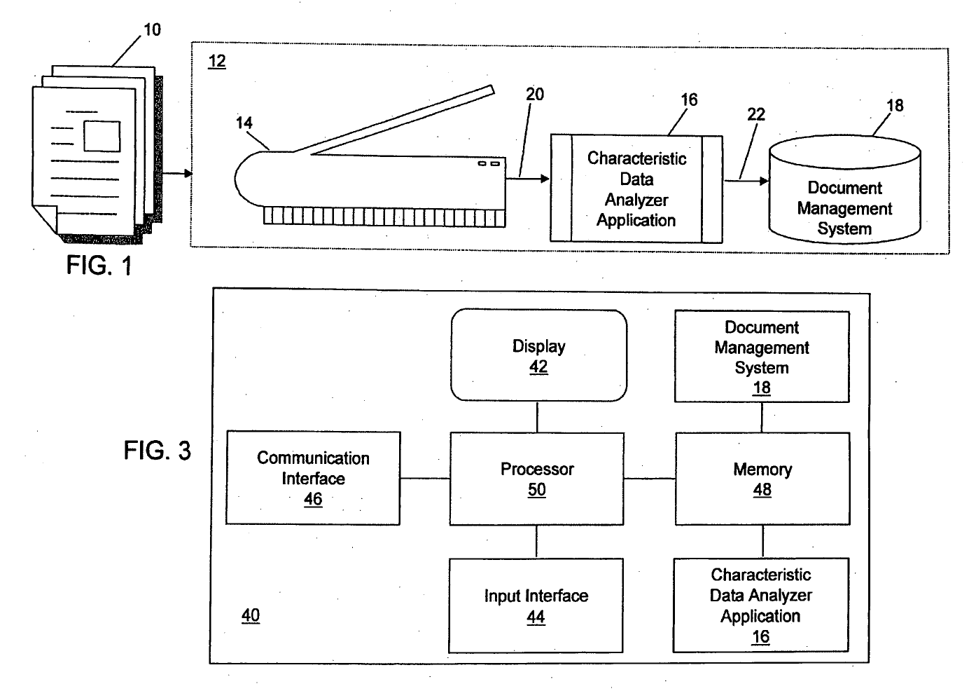

FIG. 1 is a block diagram of a characteristic data analyzer system 12 consistent with an exemplary embodiment of the present invention. As shown in FIG. 1, the system 12 includes a scanner 14, a characteristic data analyzer application 16, and a document management system 18. A document 10 that may include a plurality of pages, is scanned by the scanner 14 to create a bitmapped image file that may be saved in a variety of formats as known to those skilled in the art. In an exemplary embodiment, the bitmapped image file may be saved as a TIFF file. The bitmapped image file is input to the characteristic data analyzer application 16 that analyzes the bitmapped image file to determine characteristic data of the document 10. Example characteristic data includes, but is not limited to, a title, creation date, scan date, author, subject matter, total page count, starting page number, ending page number, color type, document type, language, and document direction for the document 10. The characteristic data is linked with the bitmapped image file in the document management system 18. Defining the characteristic data for the document allows a user of the document management system 18 to locate the document 10 easily in an electronic format for review, for editing, for printing, etc.

The elements of the system 12 may be implemented in a single device or across a plurality of devices having one or more interface capable of transmitting and receiving the appropriate data. Thus, for example, the characteristic data analyzer application 16 may be implemented as part of the scanner 14. After creating the bitmapped image file of the scanned document, the characteristic data analyzer application 16 may analyze the bitmapped image file automatically to determine the characteristic data.

In an alternative embodiment, a first interface 20 may be implemented between the scanner 14 and the characteristic data analyzer application 16 that are implemented at different devices. The first interface 20 can be a network interface or a local connection, such as a serial port or a parallel port. The first interface 20 may be implemented as a wired or a wireless interface that allows transmission of the bitmapped image file from the scanner 14 to the characteristic data analyzer application 16. A variety of communication media and communication protocols may be used as known to those skilled in the art. For example, the communication media may include, but is not limited to, a long range wireless connection, a short range wireless connection, and various wired connections including, but not limited to, telephone lines, cable lines, power lines, etc.

In an exemplary embodiment, the document management system 18 may be implemented in a single device in combination with the scanner 14 and the characteristic data analyzer application 16. Thus, the scanner 14 may include some type of storage, such as a hard disk drive, a non-volatile memory, such as a Read Only Memory (ROM), and/or a Random Access Memory (RAM) that can hold the characteristic data analyzer application 16 and the document management system 18 in addition to programming and instructions that control the operation of the scanner 14. The characteristic data determined by the characteristic data analyzer application 16 may be stored automatically with the bitmapped image file in the document management system 18.

In an alternative embodiment, a second interface 22 may be implemented between the scanner 14 and the characteristic data analyzer application 16 that are implemented in different devices. The second interface 22 can be a network interface or a local connection, such as a serial port or a parallel port. The second interface 22 may be implemented as a wired or a wireless interface that allows transmission of the bitmapped image file and the characteristic data from the characteristic data analyzer application 16 to the document management system 18. A variety of communication media and communication protocols may be used as known to those skilled in the art. For example, the communication media may include, but is not limited to, a long range wireless connection, a short range wireless connection, and various wired connections including, but not limited to, telephone lines, cable lines, power lines, etc.

FIG. 2 illustrates exemplary operations of the characteristic data analyzer application 16 included as part of system 12. As shown in FIG. 2, the characteristic data analyzer application 16 reads the bitmapped image file of the scanned document created by the scanner 14 (step 60). As discussed with reference to FIG. 1, the bitmapped image file may be received from the scanner 14 through a communication interface that includes a network interface or a local connection that may be wired or wireless. Alternatively, the bitmapped image file may be read directly by a processor implemented at the scanner 14. The characteristic data analyzer application 16 analyzes the bitmapped image file(step 62). In an exemplary embodiment, the scanner 14 determines the number of pages in the document 10 as part of the process of scanning the document 10. Additional analysis of the bitmapped image file may include one or more analysis technique applied to each page of the document 10.

In an exemplary embodiment, the additional analysis of the bitmapped image file includes, for example, performing an image layout analysis (Step 64). One function of the image layout analysis is to determine the layout direction for each page of the document 10. To determine the layout direction for each page, the image layout analysis can sum the pixel data in each row of the page and sum the pixel data in each column of the page. A row of pixels runs from the left side of the page to the right side of the page and a column of pixels is perpendicular to the row of pixels. If the page layout is “landscape” (i.e., page oriented so that the shorter side runs from the top to the bottom of the page), then the sum of each column is expected to exhibit peaks and valleys as compared to an average value calculated for all of the columns. On the other hand, if the page layout is “portrait” (i.e., page oriented so that the longer side runs from the top to the bottom of the page), then the sum of each row is expected to exhibit peaks and valleys as compared to an average value calculated for all of the rows.

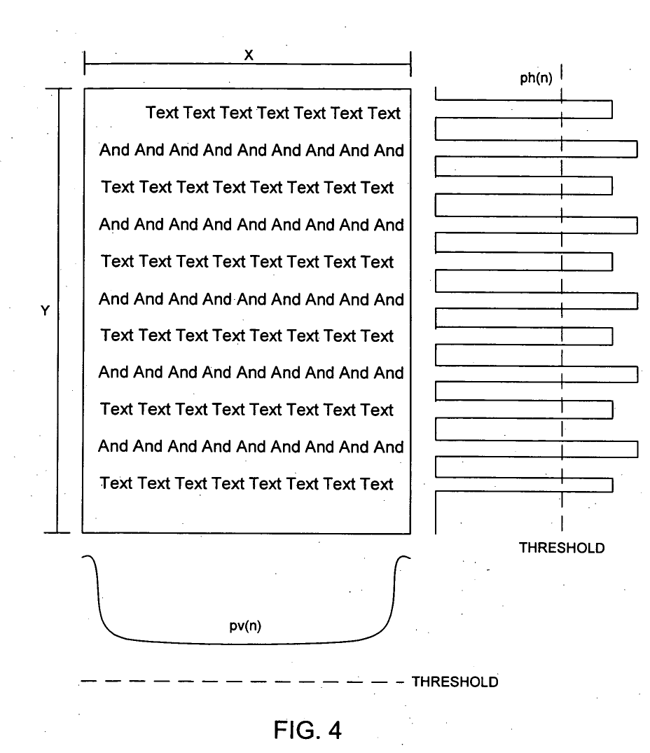

FIG. 4 shows a graphical representation of an analysis of an exemplary text document for determining layout direction. As shown in FIG. 4, an exemplary page of text is arranged with a portrait layout. The page has a size of X in the horizontal direction and Y in the vertical direction. The page is analyzed by counting the number of pixels in the horizontal direction from 0 to Y-1, and by counting the number of pixels in the vertical direction 0 to X-1. More specifically, a horizontal projection, ph, and a vertical projection, pv, are measured according to the following equations:

$$ph ( n ) = {\sum }_{i = 0}^{X - 1} d ( i , n ) , n = 0 , Y - 1 ; and$$

$$pv ( n ) = {\sum }_{i = 0}^{Y - 1} d ( n , i ) , n = 0 , X - 1 ,$$

where d(i,n) is a pixel value (0 or 1) at position (i,n), and d(n,i) is a pixel value at position (n,i). A pixel has a 0 value if there is no toner or ink to be printed on the pixel, and a pixel have a 1 value. if there is toner or ink to be printed on the pixel. Accordingly, if there are a lot of ‘1 ’ pixels in a horizontal or vertical, the corresponding projection will have a high value, whereas the projection will have a low value if there are few ‘1’ pixels.

Each of the projections is compared against a threshold, th, to determine how many horizontal projections ph(n) and how many vertical projections pv(n) exceed the threshold. The determined number of horizontal projections ph(n) and the determined number of vertical projections pv(n) are compared to each other, and the layout direction is determined based on the comparison. If the determined number of horizontal projections ph(n) is greater than the determined number of vertical projections pv(n), then the layout direction is portrait. Conversely, if the determined number of vertical projections pv(n) is greater than the determined number of horizontal projections ph(n), then the layout direction is landscape. As shown in FIG. 4, many of the horizontal projections ph(n) are greater than the threshold th, but none of vertical projections pv(n) is greater than the threshold th. Accordingly, the layout direction in FIG. 4 is determined to be portrait.

This method for determining layout direction can be altered in accordance with the language of the document. For example, whereas English is written horizontally across the page in rows, Japanese is typically written vertically across the page in columns. To account for this difference, optical character recognition (OCR) can be performed prior to the layout determination. The OCR, which is described in more detail herein, can determine the language of the page. The layout direction is determined in accordance with the determined language.

In addition to determining layout direction, the image layout analysis can locate each object on each page of the document and determine the object type. Object types include, for example, text objects, graphical objects, and image objects. The information provided by the image layout analysis thus identifies the position and type of each object.

Based on the layout direction and object types and locations for each page of the document 10, the image layout analysis can identify characteristic data of the document 10. The image layout analysis can also take into account known document formats for certain document types to help identify characteristic data of the document 10. Exemplary document types include letters and technical papers. Characteristic data identifiable from the image layout analysis of the document 10 includes, but is not limited to, a title, a creation date, a total page count, a starting page number, an ending page number, a document direction, a document type, subject matter, and an author.

For example, technical papers typically place a title, an author, and a subject matter at the top of the first page in a center location. Letters typically apply a specific format that places the creation date, subject matter, author, and letter recipient in specific locations at the top of the first page generally left justified. Additionally, page numbers are often placed in a footer of the document in a consistent location that may be right or left justified or in the center of each page. As a result, a starting page number and an ending page number can be determined in addition to the total page count, which can be identified by the scanner 14. Thus, characteristic data of the document 10 can be determined automatically by performing image layout analysis of the document 10.

The additional analysis of the bitmapped image file can also include performing a natural language analysis (step 66). The natural language analysis determines the language of the document 10 using natural language processing techniques as known to those skilled in the art. Initially, the language of the document is determined. After determining the language, computational techniques can be applied to interpret the content of the document. For example, the identification of the subject matter of the document can be determined using statistical methods to identify keywords. Additionally, a determination of the language may also allow a better understanding of the image layout of the document, and thus improve the determination by the image layout analysis of the characteristic data such as the document title, the creation date, the author, and the document type. Characteristic data identifiable from the natural language analysis of the document 10 includes, but is not limited to, subject matter, a title, a creation date, a total page count, a starting page number, an ending page number, a document direction, a document type, a language, and an author. Thus, characteristic data of the document 10 can be determined automatically by performing natural language analysis of the document 10.

Another analysis that can be performed is an Optical Character Recognition (OCR) analysis (step 68). Optical character recognition is capable of translating bitmapped images, such as ones generated by a scanner, into machine-editable text. OCR analysis can also include digital character recognition as well. Thus, using the OCR analysis, a scanned document can be translated to an editable document of text. As known to those skilled in the art, an OCR analysis system can be implemented using a combination of hardware and software though systems may be implemented entirely in software. Thus, OCR analysis determines the actual text, if any, of the document 10. After applying the OCR analysis, computational techniques can be applied to interpret the content of the document. For example, the identification of the subject matter of the document can be determined using statistical methods to determine keywords. Additionally, a determination of the text of the document may also allow a better understanding of the image layout of the document, and thus, improve the determination by the image layout analysis or the natural language analysis of characteristic data, such as the document title, the creation date, the author, and the document type. Characteristic data identifiable from the OCR analysis of the document 10 includes, but is not limited to, subject matter, a title, a creation date, a total page count, a starting page number, an ending page number, a document direction, a document type, language, and an author. Thus, characteristic data of the document 10 can be determined automatically by performing OCR analysis of the document 10.

A color analysis can also be performed (step 70). The color analysis is capable of determining if the document 10 is a color document, a black and white (B/W) document, or a grey scale document. To make the determination, the color analysis can generate histograms and determine the color format based on the generated histograms. More particularly, as described above, the scanner 14 may save each pixel of the scanned document using a certain number of bits indicating the color to be displayed for each pixel. The histograms indicate the color density of the document through evaluation of the color of each pixel on each page. For example, a document may be have text in black and white, but include color figures. Thus, the document color format is color. Instead of histograms, it is possible for the color analysis to analyze the pixel values of each page to determine the color format. For example, a color document typically has variable RGB values for each pixel, i.e., the red, green, and blue values of a pixel are different, whereas a B/W or grey scale document typically has equal RGB values for each pixel. In addition, it is also possible for the color analysis to be performed automatically by the scanner 14. Color analysis can also provide limited color information like B/W and red or B/W and blue.

Based on the analysis techniques applied to the bitmapped image data, the characteristic data is determined. The analyses may be performed in separate, sequential steps, as indicated in FIG. 2, with output from one analysis technique provided as an input to the next analysis technique. Alternatively, each analysis technique may be performed independently from the other techniques receiving only the bitmapped image file. Additionally, the analyses may be performed in a different order than that indicated in FIG. 2. The analyses may also be performed in parallel or be repeated with additional information from a subsequent analysis operation provided as an input to improve previous analysis results. Thus, feedback and feed forward loops may both be provided between the analysis techniques. For example, an initial language determination may be performed using the natural language analysis. Subsequently, the image layout analysis may be performed with knowledge of the language determination. OCR analysis may be performed to determine the text of the document based on the language and image layout analysis results. Using the text determined during the OCR analysis, additional natural language processing may be performed to interpret the text of the document. Thus, the sequence of the analyses of FIG. 2 is for purposes of illustration only and should not be interpreted to limit the scope of the invention. The characteristic data identifiable from analysis of the bitmapped image file of the document 10 includes, but is not limited to, a title, a creation date, a scan date, an author, subject matter, a total page count, a starting page number, an ending page number, a color type, a document type, language, and a document direction.

Having determined the characteristic data, a determination is made regarding how to link the characteristic data with the bitmapped image file. If the characteristic data is not saved in a characteristic data file, the characteristic data can be merged with the bitmapped image file to create a single document that is stored in the document management system 18. For example, merging the characteristic data with the bitmapped image file may include adding the characteristic data to a header of the bitmapped image file. A header includes one or more fields providing a set of information. For example, a TIFF file has a header that includes comments concerning the document and metadata associated with the document. Metadata is information about data and describes, for example, how, when, and by whom the document is created, and how the data is formatted. Metadata, thus, includes the characteristic data determined for the document 10.

A TIFF file includes an 8-byte image file header that points to an image file directory (IFD). The IFD includes information about the image (document) and pointers to the actual image data stored within the same file. The IFD is typically implemented as a two byte count of the number of directory entries (i.e., the number of fields). A TIFF field is a logical entity having a TIFF tag and its value. A TIFF tag identifies the field. For example, the TIFF standard specifies that the “artist” is specified in the field with tag number 315. Thus, the characteristic data identifying the author of the document may be placed in the value associated with TIFF tag 315. in the header of a TIFF file. Thus, the characteristic data is written to the appropriate field of the bitmapped image file based on the format used to store the bitmapped image file. Other possible formats may be used as known to those skilled in the art.

Alternatively, if the characteristic data is saved in a characteristic data file, a characteristic data file is created (step 78). The characteristic data is written to the created characteristic data file (step 80). A variety of formats may be used to write the characteristic data to the characteristic data file as known to those skilled in the art. The characteristic data file having the characteristic data is associated with the bitmapped image file (step 82). For example, the characteristic data file may have a field that includes a name and possibly a location of the bitmapped image file. In such a system, the document management system 18 searches for documents using the data written to the characteristic data file. After locating the desired characteristic data file, the bitmapped image file is also identified through a field of the characteristic data file, which associates the bitmapped image file with the characteristic data file. The characteristic data is stored with the bitmapped image file in the document management system 18 (step 84). Thus, the characteristic data may be stored with the bitmapped image file as a single file or as a separate file.

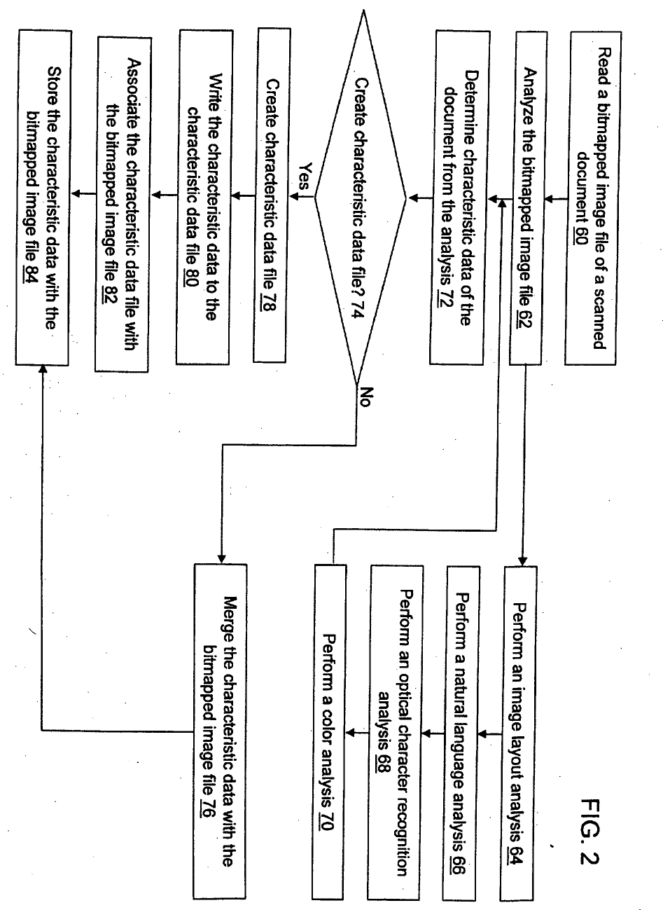

FIG. 3 shows a device 40 for performing the operations of the characteristic data analyzer application 16 and the document management system 18. The device 40 includes, but is not limited to, a display 42, an input interface 44, a communication interface 46, a memory 48, a processor 50, the characteristic data analyzer application 16, and the document management system 18. The term “device” should be understood to include, without limitation, any type of processing device, such as personal computers, workstations, servers, PDAs, or other types of hand held devices. Thus, the device 40 may or may not be mobile. Additional components may be incorporated into the device 40.

The display 42 presents information to a user of the device 40. The display 42 may be a thin film transistor (TFT) display, a light emitting diode (LED) display, a Liquid Crystal Display (LCD), a CRT display or any of a variety of different displays known to those skilled in the art. The display 42 is an optional component of the device 40. The display 42 may present the bitmapped image file to the user.

The input interface 44 provides an interface for receiving information from the user for entry into the device 40. The input interface 44 may use various input technologies including, but not limited to, a keyboard, a pen and touch screen, a mouse, a track ball, a touch screen, a keypad, one or more buttons, etc. to allow the user to enter information into the device 40 or to make selections. The input interface 44 may provide both an input and output interface. For example, a touch screen both allows user input and presents output to the user. The input interface 44 is an optional component of the device 40.

The communication interface 46 provides an interface for receiving and transmitting information communicated across a communication medium, such as a network. For example, the communication interface 46 can be configured to allow the device 40 to receive the bitmapped image file from the scanner 14. Communications between the device 40 and the network may be through one or more of the following connection methods, without limitation: an infrared communication link, a wireless communication link, a cellular network link, a serial port, a parallel port, etc. One or more of these connection methods can be used to transfer content to and from the device 40. The device 40 may communicate using various transmission technologies including, but not limited to, the transmission control protocol/Internet protocol (TCP/IP), Bluetooth, IEEE 802.11, infrared data association,. radio frequency Identification, etc. The device 40 may communicate using various media including, but not limited to, radio, infrared, laser, optical, universal serial bus, Ethernet, IEEE 1394, etc. The network includes, but is not limited to, a local area network, a wide area network, a wireless network, a Bluetooth personal area network, and the Internet. The communication interface 46 is an optional component of the device 40 if the scanner is integrated with the device 40.

The memory 48 may hold an operating system of the device 40, the characteristic data analyzer application 16, the document management system 18, and/or other applications to enable the processor to reach the information quickly. The device 40 may have one or more memories 48 using various memory technologies including, but not limited to, RAM, ROM, flash memory, disk drives, etc.

The processor 50 executes instructions that cause the device 40 to perform various functions. The instructions may be written using one or more programming language, scripting language, assembly language, etc. Additionally, the instructions may be carried out by a special purpose computer, logic circuits, or hardware circuits. Thus, the processor 56 may be implemented in hardware, firmware, software, or any combination thereof. The term “execution” is the process of running an application or the carrying out of the operation called for by an instruction. The processor 50 executes an instruction, meaning that it performs the operations called for by that instruction. The processor 50 executes the instructions embodied in the characteristic data analyzer application 16 and the document management system 18 in accordance with FIG. 3. The device 40 may include one or more processor 50. The same or a different processor 50 may execute both the characteristic data analyzer application 16 and the document management system 18.

The characteristic data analyzer application 16 can be implemented as an organized set of instructions that, when executed, cause the device 40 to perform the operations described with reference to FIG. 2. The instructions may be written using one or more programming language, assembly language, scripting language, etc. The characteristic data analyzer application 16 may execute automatically when a document is scanned or a bitmapped image file is received via the communication interface 46. Alternatively, the characteristic data analyzer application 16 may execute when selected by the user using the input interface 44 as known to those skilled in the art. To execute the characteristic data analyzer application 16, an executable form of the application can be retrieved from a non-volatile memory device and copied to a temporary memory device from which the processor 50 executes the application. The temporary memory device can be, for example, a RAM. The non-volatile memory device can be, for example, a ROM or a flash memory.

The document management system 18 can be implemented as an organized set of instructions that, when executed, cause. the device 40 to perform the operations of a document management system. Using the document management system 18, a user may identify a specific document stored in the document management system based on the characteristic data saved and associated with each document. The document management system 18 searches the characteristic data associated with each document for a match with one or more query item and provides any matching document to the user for review, for printing, for editing, etc. The document management system 18 may interface with a database as known to those skilled in the art. The document management system 18 need not be located at the device 40. Instead, the communication interface 46 may transmit the characteristic data with the bitmapped image file to another device executing the document management system 18 or accessible by the document management system 18. Thus, the document management system 18 itself may be distributed across a network.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The embodiments (which can be practiced separately or in combination) were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method for providing characteristic data associated with a document, the method comprising:
analyzing a bitmapped image file of a document;
determining at least one characteristic data of the document based on the analysis of the bitmapped image file; and
linking the characteristic data to the bitmapped image file,
wherein the characteristic data is useable by a document management system to identify the document in a search of the document management system.

2. The method of claim 1, further comprising scanning the document to create the bitmapped image file.

3. The method of claim 2, wherein the bitmapped image file is analyzed automatically after scanning the document.

4. The method of claim 1, further comprising merging the characteristic data and the bitmapped image file into a single document.

5. The method of claim 4, wherein merging the characteristic data and the bitmapped image file comprises adding the characteristic data to a header of the bitmapped image file.

6. The method of claim 1, further comprising:
storing the characteristic data in a characteristic data file; and
associating the characteristic data file with the bitmapped image file.

7. The method of claim 1, wherein analyzing the bitmapped image of the document comprises performing an image layout analysis.

8. The method of claim 7, wherein the image layout analysis determines an orientation of each page of the document and a position and a type for each object of each page of the document based on the bitmapped image file.

9. The method of claim 8, wherein the image layout analysis identifies the characteristic data based on the determined orientation and the determined object type and object position.

10. The method of claim 1, wherein analyzing the bitmapped image of the document comprises performing an optical character recognition analysis.

11. The method of claim 10, wherein the optical character recognition analysis translates text information in the bitmapped image file into machine readable text.

12. The method of claim 11, wherein the optical character recognition analysis identifies the characteristic data based on the machine readable text.

13. The method of claim 1, wherein analyzing the bitmapped image of the document comprises performing a natural language analysis.

14. The method of claim 13, wherein the natural language analysis detects a language and a keyword from the bitmapped image of the document.

15. The method of claim 14, wherein the natural language analysis identifies the characteristic data based on the detected language and keyword.

16. The method of claim 13, wherein the natural language analysis detects a language from the bitmapped image of the document, and further wherein, analyzing the bitmapped image of the document further comprises performing an image layout analysis.

17. The method of claim 16, wherein analyzing the bitmapped image of the document further comprises performing an optical character recognition analysis.

18. The method of claim 1, wherein analyzing the bitmapped image of the document comprises performing a color analysis to determine if the document is a color document.

19. The method of claim 1, wherein the characteristic data of the document is selected from the group consisting of a title, a creation date, a scan date, an author, a subject matter, a total page number, a starting page number, an ending page number, a color type, a document type, a language, and a document direction.

20. The method of claim 1, wherein analyzing the bitmapped image of the document comprises performing at least one of a natural language analysis, an optical character recognition analysis, an image layout analysis, or a color analysis.

21. The method of claim 1, further comprising:
receiving a search query at the document management system, the search query including a query item;
comparing the query item to the characteristic data; and
providing the bitmapped image file as a result of the search query based on the comparison of the query item to the characteristic data.

22. One or more computer-readable media having computer-readable instructions stored thereon that, upon execution by a processor, cause the processor to provide characteristic data associated with a document, the instructions configured to:
analyze a bitmapped image file of a document;
determine at least one characteristic data of the document based on the analysis of the bitmapped image file; and
link the characteristic data to the bitmapped image file,
wherein the characteristic data is useable by a document management system to identify the document in a search of the document management system.

23. A device for providing characteristic data associated with a document, the device comprising:
a characteristic data analyzer application, the characteristic data analyzer application comprising computer-readable instructions configured
to analyze a bitmapped image file of a document;
to determine at least one characteristic data of the document based on the analysis of the bitmapped image file; and
to link the characteristic data to the bitmapped image file,
wherein the characteristic data is useable by a document management system to identify the document in a search of the document management system;
a memory, wherein the memory stores the characteristic data analyzer application; and
a processor coupled to the memory, the processor configured to execute the characteristic data analyzer application.
